(19) United States
(12) Patent Application Publication
(10) Pub. No.: US 2006/0068139 A1
(43) Pub. Date: Mar. 30, 2006

(54) Rotational-molded resin fuel tank

(75) Inventors: Nobuo Fujitaka, Wako-shi (JP); Akihito Kobayashi, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 11/229,859

(22) Filed: Sep. 20, 2005

(30) Foreign Application Priority Data
Sep. 30, 2004 (JP) 2004-286112

(51) Int. Cl. B32B 27/08

(52) U.S. Cl. 428/35.7

(57) ABSTRACT

A resin fuel tank having a two-layer structure of inner and outer layers is formed by rotational molding so as to be superior not only in appearance but also in weathering resistance, low temperature impact resistance and resistance to gasoline permeability.

### FIELD OF THE INVENTION

The present invention relates to a resin fuel tank in a motorcycle or the like and more particularly to a resin fuel tank having a multi-layer structure obtained by rotational molding.

### BACKGROUND OF THE INVENTION

It is publicly known to form a fuel tank for gasoline in a motorcycle or the like with use of resin. Blow molding using a high-density polyethylene resin is known as a method for producing such a resin fuel tank. As an example there is known a resin fuel tank having two inner and outer layers, produced by laminating resin materials of different colors into two layers and by subsequent blow molding (see Japanese Patent Laid-Open No. Hei 7-125665 (JP '655)).

Resin fuel tanks have recently been required to have improved resistance to gasoline permeability. This requirement can be met by forming a resin fuel tank of a multi-layer structure. However, if blow molding is performed as in JP '665, there occurs surface roughening or flow mark due to pulsation or the like when parison is discharged from a blow molding machine into the air through a die casting core, which surface roughening or flow mark sometimes appears on the surface of the resulting molded product. Besides, a high-density polyethylene resin is poor in fluidity and is also low in mold transferability because blowing of air is performed at a relatively low pressure. This is sometimes disadvantageous to the fuel tank of a motorcycle, where the appearance is important. Moreover, for blow-molding a multi-layered material, a high level of technique is required to ensure adhesion between the laminated materials. Further, such a relatively complicated shape as the fuel tank of a motorcycle is difficult to undergo blow molding and morphological restrictions have sometimes occurred heretofore.

Accordingly, it is an object of the present invention to provide a resin fuel tank of a multi-layer structure superior in appearance, not by blow molding.

### SUMMARY OF THE INVENTION

For solving the above-mentioned problems, according to the instant invention, there is provided a rotational-molded resin fuel tank having at least an inner layer and an outer layer, characterized in that the inner and outer layers are formed by rotational molding within one and same mold using different resins.

Further, there is provided a rotational-molded resin fuel tank as described above, wherein the outer layer is formed of a resin superior in weathering resistance and low temperature impact resistance and the inner layer is formed of a resin superior in resistance to gasoline permeability.

There is also provided a rotational-molded resin fuel tank as described above, wherein the outer layer is formed of a polyethylene resin and the inner layer is formed of a polyamide resin or a copolymer of the polyamide resin with a polyethylene resin.

Additionally, there is provided a rotational molded resin fuel tank, wherein the resin of the inner layer is a lower melting resin included in the same system of resins as that of the inner layer resin.

Additionally, there is provided a rotational-molded resin fuel tank, having a three-layer structure including an intermediate layer between the inner and outer layers, the outer layer being formed of a resin superior in weathering resistance and low temperature impact resistance, the inner layer being formed of a resin superior in resistance to gasoline permeability, and the intermediate layer being formed of a resin superior in adhesion to both the inner and outer layers.

There is provided a three-layer rotational-molded resin fuel tank as described above, wherein the outer layer is formed of a polyethylene resin, the inner layer is formed of a fluorine resin, and the intermediate layer is formed of a polyamide resin. A copolymer of the polyamide resin with a polyethylene resin is included as an example of the said polyamide resin.

According to the instant invention, since the resin fuel tank is formed by rotational molding of a powdered resin, such a resin material discharge step as in blow molding is not present and therefore a phenomenon which spoils the appearance of the tank, e.g., flow mark, does not occur. Besides, since the mold transferability is good, it is possible to obtain a resin fuel tank superior in appearance. Moreover, since it is possible to effect molding of complicated shapes, the degree of freedom in shape becomes high.

Further, a resin fuel tank of a multi-layer structure having at least inner and outer layers can be produced by rotational molding of different resins within one and the same mold. Additionally, the adhesion between the inner and outer layers can be enhanced by rotational molding.

Further, since a resin superior in weathering resistance and low temperature impact resistance is selected as the material of the outer layer and a resin superior in resistance to gasoline permeability is selected as the material of the inner layer, appearance, low temperature impact resistance and resistance to gasoline permeability can be complemented by the physical properties of the inner and outer layers to such an extent as is required of the resin fuel tank. Thus, it is possible to form a resin fuel tank having the above required physical properties which cannot be attained by the use of a single-layer resin.

Further, the outer layer may be formed using a polyethylene resin which is superior in weathering resistance and low temperature impact resistance and is relatively inexpensive, but is inferior in resistance to gasoline permeability, while the inner layer may be formed of a polyamide resin which is superior in resistance to gasoline permeability but is inferior in weathering resistance and low temperature impact resistance and is high in material cost, or a copolymer of the polyamide resin with a polyethylene resin. Therefore, the performance of the whole of the resin fuel tank can be improved by complementarily utilizing the characteristics of those resins. In the case of forming the inner layer with use of a copolymer of both polyamide resin and polyethylene resin, the bonding of the inner layer with the outer layer of polyethylene resin becomes stronger.

Additionally, there may be used, as the resin of the inner layer, a lower melting resin included in the same system of resins as that of the inner layer resin, whereby the inner layer difficult to be heated can be molded at a relatively low temperature. Consequently, it becomes easier to form a resin fuel tank of a multi-layer structure by rotational molding.

There is also provided a three-layer structure having an intermediate layer between the inner and outer layers, wherein the outer layer is formed of a resin superior in weathering resistance and low temperature impact resistance, the inner layer is formed of a resin superior in resistance to gasoline permeability, and the intermediate layer is formed of a resin superior in adhesion to both inner and outer layers. Consequently, the bonding among the multiple layers can be made stronger.

Further, in the three-layer resin fuel tank described above, since the outer, inner, and intermediate layers are formed of a polyethylene resin, a fluorine resin, and a polyamide resin, respectively, not only excellent appearance resistance to gasoline permeability can be ensured by the polyethylene resin of the outer layer and the fluorine resin of the inner layer, respectively, but also the bonding between the inner and outer layers can be strengthened by the polyamide resin of the intermediate layer. Besides, the polyamide resin of the intermediate layer complements the resistance to gasoline permeability of the fluorine resin and thus it is possible to improve the resistance to gasoline permeability of the whole of the resin fuel tank.

### BRIEF DESCRIPTION OF THE DRAWINGS

The advantages of the invention will become apparent in the following description taken in conjunction with the drawings, wherein:

FIG. 1 is a schematic sectional view of a fuel tank for a motorcycle according to the present invention;

FIG. 2 is a process chart explaining a rotary molding method adopted in the present invention;

FIG. 3 is a partial enlarged sectional view showing an example of a three-layer structure; and

FIG. 4 is a partially cutaway schematic diagram showing an example of an underfloor tank.

### DETAILED DESCRIPTION OF THE INVENTION

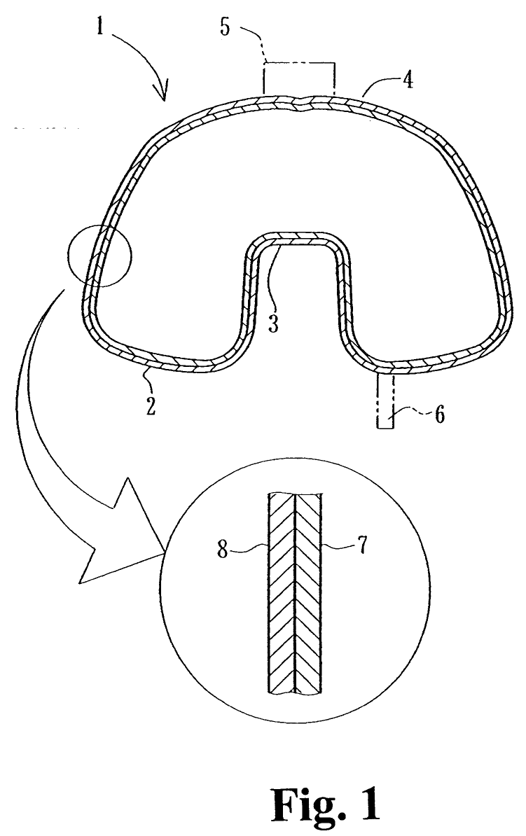

An embodiment of the present invention will be described hereinunder with reference to the drawings. FIG. 1 is a sectional view of a resin fuel tank for gasoline in a motorcycle to which the present invention is applied. The resin fuel tank, indicated at 1, is formed in the shape of a vessel as a whole and a generally inverted U-shaped groove 3 is formed longitudinally and centrally of a bottom 2 of the tank. Thus, the tank 1 has a relatively complicated shape. A body frame (not shown) is fitted in the groove 3. Further, a fuel inlet 5 and a discharge pipe 6 are integrally provided in an upper portion 4 and the bottom 2, respectively.

As shown in an enlarged portion of the same figure, the resin fuel tank 1 has a two-layer structure of an inner layer 7 and an outer layer 8. The inner layer 7 is formed of a resin superior in resistance to gasoline permeability, e.g., a polyamide resin or a copolymer thereof with a polyethylene resin. In the following description the polyamide resin alone is used and reference to the copolymer will be made later. The outer layer 8 is formed of a resin superior in weathering resistance and low temperature impact resistance, e.g., a polyethylene resin.

The melting point of the polyamide resin used in the inner layer 7 is generally higher than that of the polyethylene resin used in the outer layer 8 and therefore a polyamide resin as low as possible in melting point is selected. For this purpose it is preferable to select, from among polyamide resins, polyamide 12 which is relatively low in melting point.

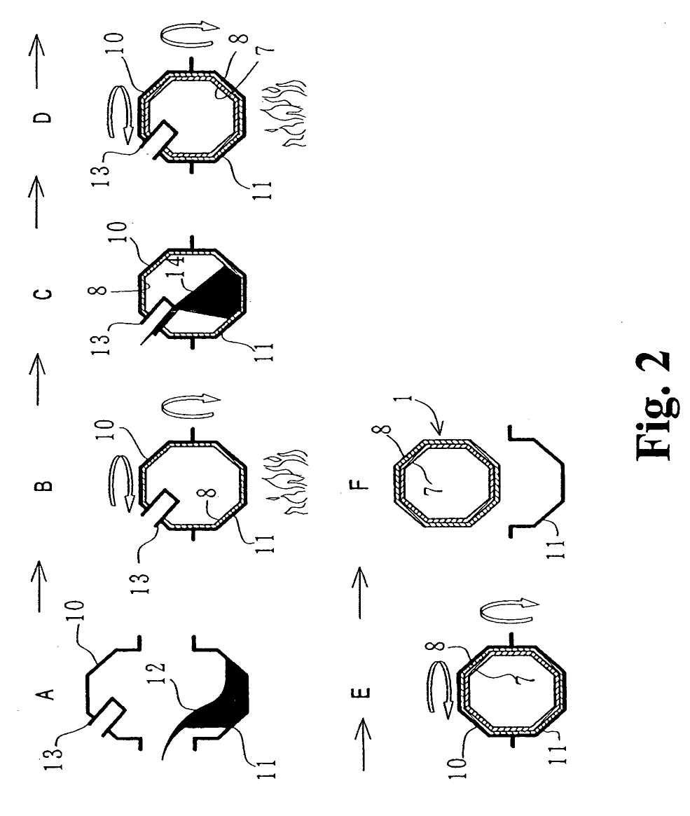

The resin fuel tank 1 is formed by rotational molding which is publicly known. FIG. 2 schematically shows a rotational molding method for the resin fuel tank 1. First, step A represents a material introducing step for the outer layer, in which a resin material 12 for the outer layer 8 is introduced inside an upper mold half 10 and a lower mold half 11 as vertically divided mold halves. Inner surfaces of the upper mold half 10 and the lower mold half 11 are in conformity with the profile of the resin fuel tank 1. A nozzle 13 is provided in the upper mold half 10.

Step B represents a heating step, in which the upper mold half 10 and the lower mold half 11 are placed in a clamped state into a heating furnace and is subjected to biaxial rotation while being heated to the melting point of the resin material or thereabouts. At this time it is important that the rotation be made 360° uniformly. As a result, the resin material 12 melts and adheres to the inner surfaces of the upper mold half 10 and the lower mold half 11. Even a complicated shape is formed accurately because of rotational molding. The thickness of the outer layer 8 can be adjusted as desired by adjusting the heating temperature and heating time.

Step C represents a material introducing step for the inner layer. Immediately after formation of the outer layer 8 in step B, a resin material 14 for the inner layer 7 is fed from the nozzle 13 to the inside of the outer layer 8 which has been formed within the upper mold half 10 and the lower mold half 11.

Step D represents a heating step, in which heating is performed as in step B. In this heating step, the heating temperature is set at approximately the same as the melting point of the polyamide resin 12 which is a resin material for the inner layer 7. This melting point is a lower temperature in comparison with the melting points of polyamide resins included in the same system. Therefore, even in a state in which the inner layer 7 present inside the outer layer 8 is difficult to be heated to a relatively high temperature, the resin material for the inner layer 7 can be melted to a satisfactory extent and adhered to the inside of the outer layer 8, whereby the inner layer 7 can be formed integrally with the outer layer 8. Thus, the moldability is improved.

Step E represents a cooling step, in which the inner layer 7 and the outer layer 8 are cooled and solidified to a satisfactory extent while subjecting the upper mold half 10 and the lower mold half 11 to biaxial rotation.

Step F represents a product removing step, in which the upper mold half 10 and the lower mold half 11 are separated from each other to open the mold and the resin fuel tank 1 is taken out. The resin fuel tank 1 in this stage is not a final product, but this stage is followed by a required finishing process such as deburring. Coating or the like may also be performed as necessary.

Thus, a resin material 12 for an outer layer is introduced inside an upper mold half 10 and a lower mold half 11 (step A) and rotational molding is performed under heating to form an outer layer 8 (step B). Immediately thereafter, a resin material 14 for an inner layer is introduced inside the outer layer 8 from a nozzle 13 (step C) and rotational molding is performed under heating (step D). Then, after cooling (step E), a resin fuel tank 1 as product is taken out (step F). A polyethylene resin superior in weathering resistance and low temperature impact resistance is selected as the resin material 12 for the outer layer and a polyamide resin superior in resistance to gasoline permeability, especially a polyamide resin as low as possible in melting point, is selected as the resin material 14 for the inner layer.

Thus, according to the present invention, the resin fuel tank 1 of a two-layer structure comprising the inner layer 7 and the outer layer 8 is formed by rotational drawing and therefore such an appearance defect as in blow molding does not occur. That is, since the outer layer 8 is formed by rotational molding of a powdered polyethylene resin, such a discharge step as in blow molding is not present, so that an appearance defect such as a flow mark or surface roughening does not occur. Besides, since the material is superior in fluidity to the material used in blow molding, the mold transferability is also improved.

Consequently, the resulting molded product has an appearance which fully withstands use and is lustrous. Thus, the molded product is excellent in both luster and appearance and is therefore advantageous particularly as a resin fuel tank in a motorcycle or the like in which importance is attached to the appearance of the tank as a conspicuous exterior tank disposed between a seat and handlebars.

Moreover, although the tank is of a multi-layer structure, a complicated shape can be formed as desired. Besides, the inner layer 7 and the outer layer 8 are improved in mutual adhesion by two-step rotational molding. Further, since a copolymerization reaction occurs during heating, between the inner layer 7 and the outer layer 8, it is possible to further enhance the bonding force and improve the durability.

The resin material of the inner layer 7 and the outer layer 8 which are formed by rotational molding is a resin powder. By making the particle diameter of the resin powder as small as possible and diminishing variations in particle diameter, a copolymer of the resins of the inner and outer layers 7, 8 can be made easier to obtain in two-step rotational molding.

Employable resins are not limited to those referred to above, but various thermoplastic resins are suitably employable insofar as they satisfy the foregoing conditions for use. A suitable thickness of the inner layer 7 and that of the outer layer 8, as well as a thickness ratio between the two, are determined depending on required low temperature impact resistance and resistance to gasoline permeability and can be adjusted freely by adjusting conditions for rotational molding.

Besides, since the nozzle 13 is provided, the outer layer 8 which is formed in a hollow shape can be broken and the resin material 14 can be fed easily to the inside of the outer layer. Preferably, the nozzle 13 is disposed at a position not affecting the appearance of product, for example, it is disposed by utilizing the fuel inlet 5.

As described above, the inner layer 7 may be formed using a copolymer of a polyethylene resin and a polyamide resin. The polyethylene resin is superior in weathering resistance and low temperature impact resistance and is relatively inexpensive, but is inferior in resistance to gasoline permeability. On the other hand, the polyamide resin is superior in resistance to gasoline permeability, but is inferior in weathering resistance and low temperature impact resistance and the cost thereof is high. Thus, both resins are complementary to each other as constituent materials of the resin fuel tank.

Therefore, if a copolymer of both polyethylene resin and polyamide resin is used as the material of the inner layer 7, it is possible to improve the low temperature resistance and resistance to gasoline permeability of the resin fuel tank as a whole. In this case, a mixture of both polyethylene resin and polyamide resin is used and is copolymerized by rotational molding. At this time, the physical properties of the inner layer 7 can be controlled freely by adjusting the mixing ratio of both resins. Besides, since the inner layer contains a component common to the polyethylene resin in the outer layer 8, it is possible to strengthen the bonding between the inner and outer layers.

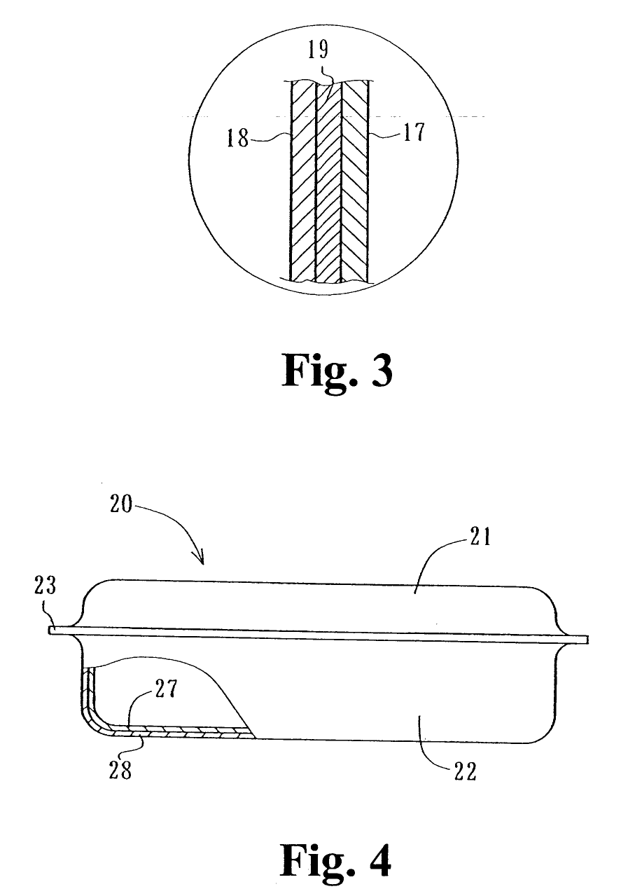

The number of layers is not limited to two which are inner and outer layers, but may be a larger number. In this case, the rotational molding may be done in multiple steps corresponding to the number of layers to be formed. Such an example is shown in FIG. 3. In the same figure, the resin tank 1 shown in FIG. 1 is made into a three-layer structure by rotational molding and a part thereof is shown like the enlarged section shown in FIG. 1. An intermediate layer 19 is formed between an inner layer 17 and an outer layer 18. The outer layer 18 is formed using a resin superior in weathering resistance and low temperature impact resistance, the inner layer 17 is formed using a resin superior in resistance to gasoline permeability, and the intermediate layer 19 may be formed using a resin superior in adhesion to both inner and outer layers.

As resins used in such a structure there may be used a polyethylene resin for the outer layer 18, a fluorine resin for the inner layer 17, and a polyamide resin for the intermediate layer 19. In this case, the fluorine resin as the material of the inner layer 17 is superior in resistance to gasoline permeability. Particularly, ETFE (ethylene/tetrafluoroethylene copolymer) as a fluorine resin is superior in the permeation of gasohol.

The polyamide resin in the intermediate layer 19 is superior in the adhesion to both polyethylene resin in the outer layer 18 and fluorine resin in the inner layer 17, making it possible to strengthen the bonding among those three layers. Besides, since the polyamide resin itself in the intermediate layer 19 is superior in resistance to gasoline permeability, it is possible to improve the resistance to gasoline permeability of the whole of the resin fuel tank.

The intermediate layer 19 may be formed using a polyamide resin, including a copolymer of both polyethylene resin and polyamide resin. By so doing, physical properties of polyethylene resins, etc. can be added freely and it is thereby possible to further strengthen the bonding between the inner and outer layers.

The position of the resin fuel tank in the motorcycle is not limited to the location described above. For example, the resin fuel tank may be one which is used as an underfloor tank. FIG. 4 is a schematic diagram showing an example of an underfloor tank. The illustrated resin fuel tank, indicated at 20, is a hollow resin tank produced by forming an upper portion 21, a lower portion 22 and a surrounding flange 23 integrally by rotational molding. An outer shell portion including a hollow portion is of a two-layer structure having an inner layer 27 and an outer layer 28 like the foregoing two-layer structure. The resin fuel tank 20 is not such a type as shown in FIG. 1 in which the tank is supported while straddling the body frame. But it has such a generally flat shape as is disposed under the floor of a scooter type vehicle for example and is secured to the vehicle body by the mounting flange 23. According to the rotational molding method adopted in the present invention, even such a type of resin fuel tank 20 can be formed easily. Like the foregoing, the resin fuel tank 20 can also be made freely into a multi-layer structure of three layers or more. Further, this resin fuel tank is applicable not only to the motorcycle but also to buggies and various general-purpose vehicles.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

We claim:

1. A rotational-molded resin tank, comprising:
an outer layer; and
an inner layer, wherein said inner and outer layers are formed by rotational molding using different resins.

2. The rotational-molded resin tank of claim 1,
wherein said outer layer is formed of a resin superior in both weathering resistance and low temperature impact resistance, and said inner layer is formed of a resin superior in resistance to gasoline permeability.

3. The rotational-molded resin tank of claim 2,
wherein said outer layer is formed of a polyethylene resin and said inner layer is formed of a polyamide resin or a copolymer of the polyamide resin with a polyethylene resin.

4. The rotational-molded resin tank of claim 1,
wherein the resin of said inner layer is a lower melting resin included in the same system of resins as that of the inner layer resin.

5. The rotational-molded resin tank of claim 1, further comprising:
an intermediate layer between said inner and outer layers, thus forming a three-layer structure,
wherein said outer layer is formed of a resin superior in weathering resistance and low temperature impact resistance, said inner layer is formed of a resin superior in resistance to gasoline permeability, and said intermediate layer being formed of a resin superior in adhesion to both said inner and outer layers.

6. The rotational-molded resin tank of claim 5,
wherein said outer layer is formed of a polyethylene resin, said inner layer is formed of a fluorine resin, and said intermediate layer is formed of a polyamide resin.

7. A rotational-molded resin tank, comprising:
an outer layer formed of a resin superior in both weathering resistance and low temperature impact resistance, including a polyethylene resin; and
an inner layer formed of a resin superior in resistance to gasoline permeability, said inner and outer layers being formed by rotational molding using different resins, wherein said inner layer is formed of a polyamide resin or a copolymer of the polyamide resin with a polyethylene resin, and further wherein said inner layer is a lower melting resin included in the same system of resins as that of the inner layer resin.
